(19) United States
(12) Patent Application Publication
(10) Pub. No.: US 2019/0125132 A1
(43) Pub. Date: May 2, 2019

(54) MARIJUANA GRINDING AND DISPENSING SYSTEM

(71) Applicants: Warren Allan Powers, Beaumont (CA); Sabrina Leung Powers, Beaumont (CA)

(72) Inventors: Warren Allan Powers, Beaumont (CA); Sabrina Leung Powers, Beaumont (CA)

(21) Appl. No.: 15/800,392

(22) Filed: Nov. 1, 2017

(51) Int. Cl. A47J 42/34; A47J 42/38

(52) U.S. Cl. CPC A47J 42/34; A47J 42/14; A47J 42/38

(57) ABSTRACT

The present invention relates to a system for preparing and dispensing [medical] marijuana, comprising: a grinder for preparing marijuana, the grinder comprising a grinder label for a user-designed mark of the contents of the grinder; and a dispenser, the dispenser comprising a storage portion for prepared marijuana, and a dispensing portion, the dispensing portion sized to hold a dispense a fixed amount of prepared marijuana through a dispensing opening, with the storage portion and the dispensing portion being in fluid communication with each other, the dispenser further comprising a dispenser label for a user-designed mark of the contents of the dispenser.

### FIELD OF THE INVENTION

The present invention relates generally to grinders and dispensers and, in particular, to a grinder and dispenser combination for use with the preparation and dispensing of medical marijuana.

### BACKGROUND OF THE INVENTION

As medical marijuana has become acceptable for use, in treatment of certain medical conditions, a growing concern for patients is in tracking the prepared product to ensure correct use. While medical marijuana is generally supplied in labelled containers, similar to conventional prescription drugs, in order to prepare medical marijuana for consumption, a portion must be prepared in a grinder. However, once ground, any unused product which is saved must then be properly tracked.

This problem is aggravated by the multiples types of medical marijuana and their different varieties and formulations for use. For example, a strongly sativa-based marijuana would not be suitable for use at night, as the user may have difficulty becoming restful and sleeping. Similarly, a strongly indica-based marijuana would not be suitable for morning or daytime use, as the effect tends to make the user lethargic and sleepy. However, many users have and use both types, depending on the nature of their condition and desired treatment. Thus, confusing the products presents a risk to the user equivalent to mixing up or incorrectly using conventional prescription medications.

It would be desirable to have a system for preparing and storing medical marijuana which mitigates some of these disadvantages.

Accordingly, there remains a need for improvements in the art.

### SUMMARY OF THE INVENTION

In accordance with an aspect of the invention, there is provided a grinder, dispenser and case combination for use with the preparation, storing and dispensing of medical marijuana.

According to an embodiment of the invention, there is provided a system for preparing and dispensing marijuana, comprising: a grinder for preparing marijuana, the grinder comprising a grinder label for a user-designed mark of the contents of the grinder; and a dispenser, the dispenser comprising a storage portion for prepared marijuana, and a dispensing portion, the dispensing portion sized to hold a dispense a fixed amount of prepared marijuana, through a dispensing opening, with the storage portion and the dispensing portion being in fluid communication with each other, the dispenser further comprising a dispenser label for a user-designed mark of the contents of the dispenser.

According to a further embodiment of the invention, there is provided.

Other aspects and features according to the present application will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example only, embodiments of the invention, and how they may be carried into effect, and in which:

FIG. 1 is a perspective view of a marijuana grinder according to an embodiment;

FIG. 2 is a perspective view of a marijuana dispenser according to an embodiment;

FIG. 3 is a side view of the dispenser of FIG. 2;

FIG. 4 a perspective view of a case according to an embodiment; and

FIG. 5 is a cut-away view of a storage bottle according to an embodiment.

Like reference numerals indicate like or corresponding elements in the drawings.

### DETAILED DESCRIPTION OF THE EMBODIMENTS

The present invention relates generally to marijuana grinders and dispensers and, in particular, to a grinder and dispenser combination for use with the preparation and dispensing of medical marijuana.

Medical marijuana comes in many different varieties to treat different conditions, similar to conventional prescription drugs. Differences in the varieties include sativa (stimulant-type) vs. indica (sedative-type) strains, THC content, and CBD content. Each variety is generally directed for use at a certain time of day (morning, day, night) and treatment of a known condition (pain, depression, appetite stimulation, etc.), A user may have several varieties available to them, making it important that they select and prepare the correct one.

Medical marijuana requires preparation (grinding) for proper dispensing and consumption. Generally, a portion of the marijuana is removed from the original packaging and placed into a grinder for preparation. The prepared marijuana is then dispensed for consumption, generally by vaporization or ingestion. It is not advised to grind more than is necessary as the ground product will lose potency over time, thus, the majority is kept in its original packaging to protect against degradation from air and light.

However, it is common for marijuana buds to be of a size and weight greater than that necessary to prepare a dose. Thus, the user generally has an excess of prepared ground product that needs to be stored and tracked. Common commercially sold hand grinders are approximately 2 inches in diameter, and are meant for grinding 2 or more buds at a time. This amount substantially exceeds the amount typically used for a dose. For example, many buds are on the order of 1-2 g in weight, where a dose is on the order or 0.25-0.50 g.

Additionally, where a user has multiple varieties on hand for treatment, cross-contamination of grinders and storage containers should also be avoided.

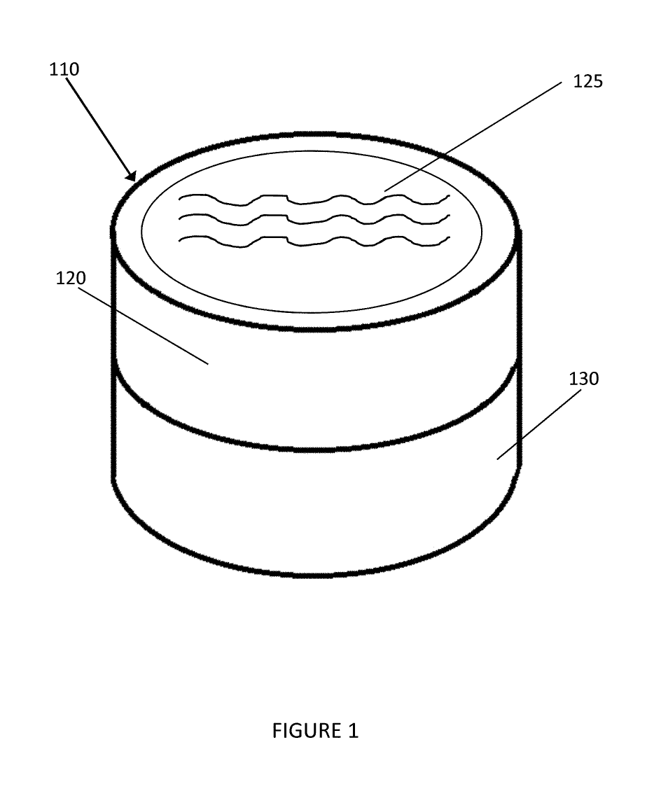

According to an embodiment as shown in FIG. 1, a grinder 110 comprises two halves, a top half 120 and a bottom half 130. Internally, grinder 110 may have additional components (e.g. blades, sieves, etc.) depending on the type of grinder, however, the external appearance is substantially similar. Top half 120 is provided with a grinder label 125 which permits a user to write a user-designed mark on the grinder 110 as to the contents and/or use.

Grinder label 125 may be integrated into top half 120, or provided as a separate label with an adhesive to secure grinder label 125 to the top half 120. The material may be re-writeable, such as a chalkboard material or a dry-erase material, to permit the user to make changes to the mark without replacing the label 125.

The user may use the label 125 for marks which carry meaning only to the user as a security function. For example, a grinder used for a sativa-based strain may be labelled as “morning” or “#1” to prevent others from readily identifying the use and contents of the grinder.

Additionally, the label 125 may have its own visual mark, such as shape, color or a symbol or pattern, which may also be used by the user to identify the grinder 110 and its contents. These marks may also be used to connect common elements of a kit as discussed below.

One method of providing grinder label 125 may be to paint the top half 120 with a chalkboard spray paint. Top half 120 may require preparation by sanding and/or priming prior to applying the paint. Painting may permit an existing grinder 110 to be modified for use with the present invention.

Another method is to provide grinder labels 125 as adhesive-backed label to be applied to grinder 110 by the user. The adhesive-backed label may also allow the user to modify the grinder label 125 prion to application, either to change the size to fit the grinder 110, or to produce different visual marks by modifying the shape of the labels.

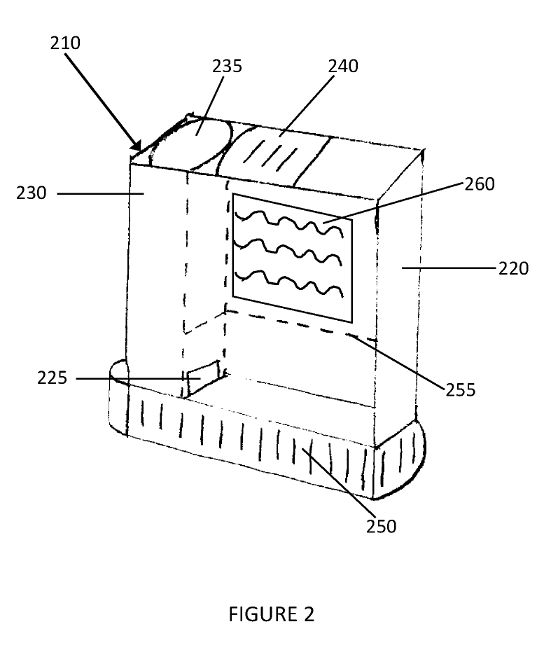

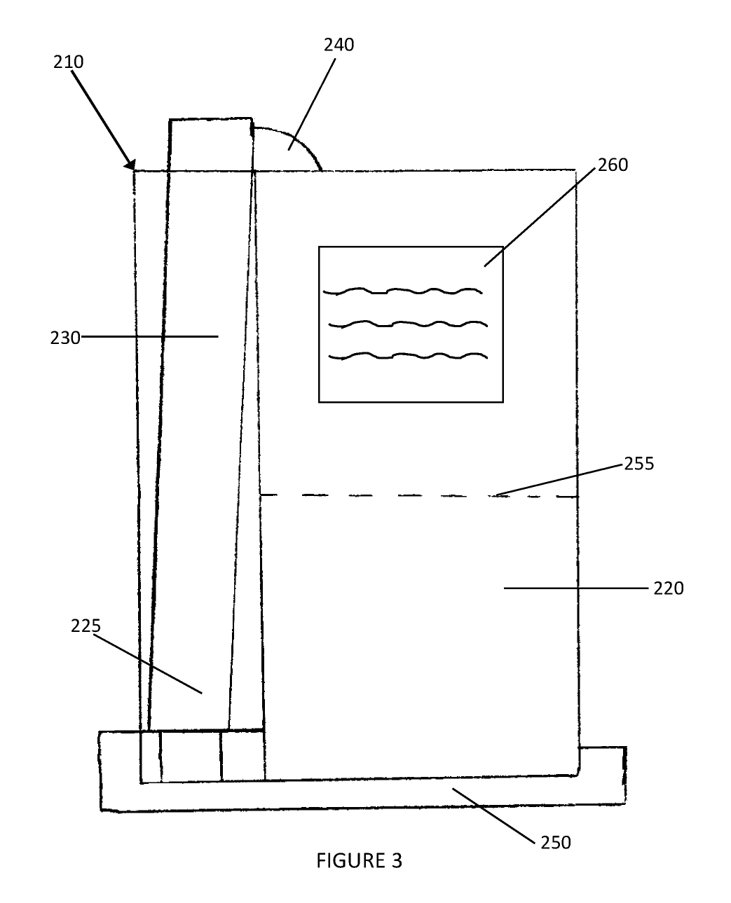

According to an embodiment as show in in FIGS. 2 and 3, a dispenser 210 is provided to store and dispense ground and prepared marijuana. The dispenser 210 has a storage portion 220 in fluid communication with a dispensing portion 230 via channel 225. The dispensing portion has an opening 235 at one end protected by a slidable cover 240 to permit marijuana to be dispensed from the dispensing portion. The base 250 of the dispenser 210 may be removable to allow the storage portion 220 to be filled from grinder 110 or another container. Dispenser 210 may further include a dispenser label 260 to permit a user to write a user-designed mark for the contents of the dispenser similarly to grinder label 125.

In operation, the user fills storage portion 220 by removing base 250 and filling storage portion 220 with prepared marijuana from grinder 110 or another container. Storage portion 220 may include one or more fill lines 255, either to indicate an amount in storage portion 220, or as a maximum fill indicator to permit operation. Base 250 is then replaced. When the user desires to dispense the required amount of prepared marijuana, dispenser 210 is shaken such that the prepared marijuana flows from storage portion 220 through channel 225 and into dispensing portion 230. When dispensing portion 230 is full, the user may then expose the opening 235 by moving the slidable cover 240, the transfer the desired amount of prepared marijuana from dispenser portion 230 to the consumption mechanism (vaporizer, etc.)

Depending on the user's consumption and storage requirements, both storage portion 220 and dispensing portion 230 may be provided in different sizes. For example, storage portion 220 may be sized to hold full-gram amounts of prepared marijuana (e.g. 1 g to 5 g capacity), while dispensing portion 230 may be sized to hold fractional gram amounts of prepared marijuana (e.g. 0.10 g to 0.75 g). Additionally, dispensing portion 230 may be removable and replaceable, to allow for different dispensing amounts to be used with the same storage portion 220.

As a safety feature, both base 250 and slidable 240 may include child-proof locking mechanism to prevent misuse, as well as any accidental opening during handling or transport.

Dispenser label 260 may be blank, or may have its own visual mark, such as shape, color or a symbol or pattern as discussed with grinder label 125 above. These visual marks may be the same for both grinder label 125 and dispenser label 260 to allow for ease of identification as a matched pair of grinder 110 and dispenser 210. For example, the labels may include a sunburst (for daytime use) or a moon (for nighttime use), allowing for the grinder 110 and dispenser 210 to be readily identified and matched without the need to further read the user-designed marks on the labels.

Thus, dispenser 210 may provide a mechanism and method to permit a user to prepare a quantity of marijuana beyond a single dose (e.g. for a full day, or for a full week), with reduced risk of damage and loss of potency compared to storing prepared marijuana in a grinder, while also provide a mechanism and method to dispense the required dosage amount for consumption.

Dispenser 210 may be made of different materials, such as plastic, glass and metal, with the different components made of different materials as is suitable for their function. As discussed above, dispenser label 260 may be integrated in the construction of dispenser 210, or provided as adhesive-backed label to be applied by the user, as with the grinder label 125 discussed above.

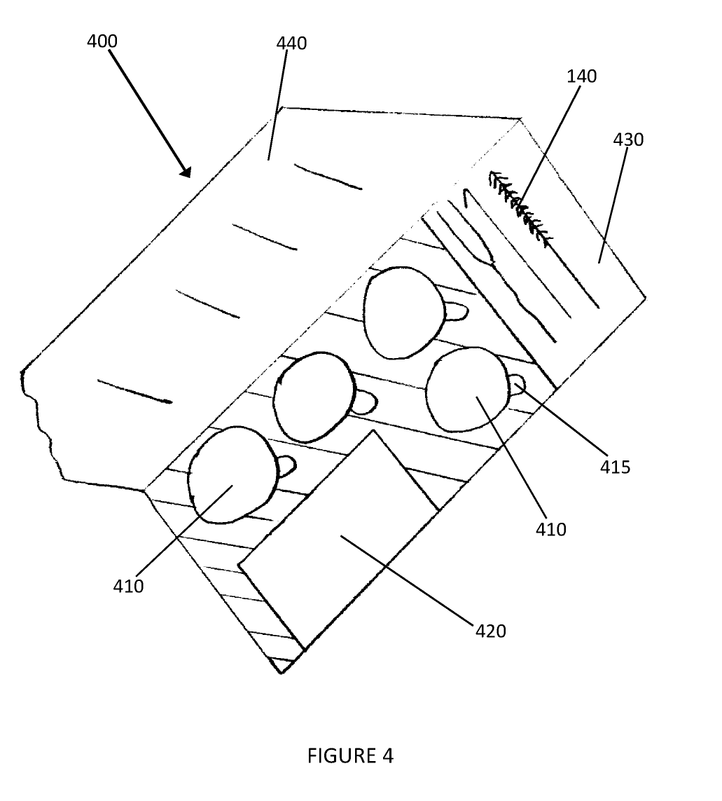

According to an embodiment as shown in FIG. 4, a case 400 may be provided to store one or more grinders 110 and one or more dispensers 210 for ease of handling and transportation. Case 400 may have one or more compartments 410 shaped to hold different shapes and sizes of grinders 110. Other compartments 420 may be shaped to hold different shapes and sizers of dispensers 210, as well as extra dispensing portions 230, where such dispensing portions are removable and replaceable from the dispenser 210.

Other compartments 430 may be provided to hold cleaning tools and other implements required for the safe and healthy preparation of medical marijuana for consumption. A flat compartment or pouch 440 may be provided in the lid for storage of medical documents, licenses, and the like. Compartments 410 may include features such as thumb holes 415 for ease in insertion and removal of grinders.

Case 400 may have an exterior shell of PVC, leather, canvas, metal or other materials as known in the art, and the interior compartments made of PVC, metal, wood or other materials with a lining of felt, high-density foam, or similar impact and shock-resistant material. Case 400 may further include a RFID or similar identification and tracking device either as part of the internal construction or in a concealed location, for a removable device.

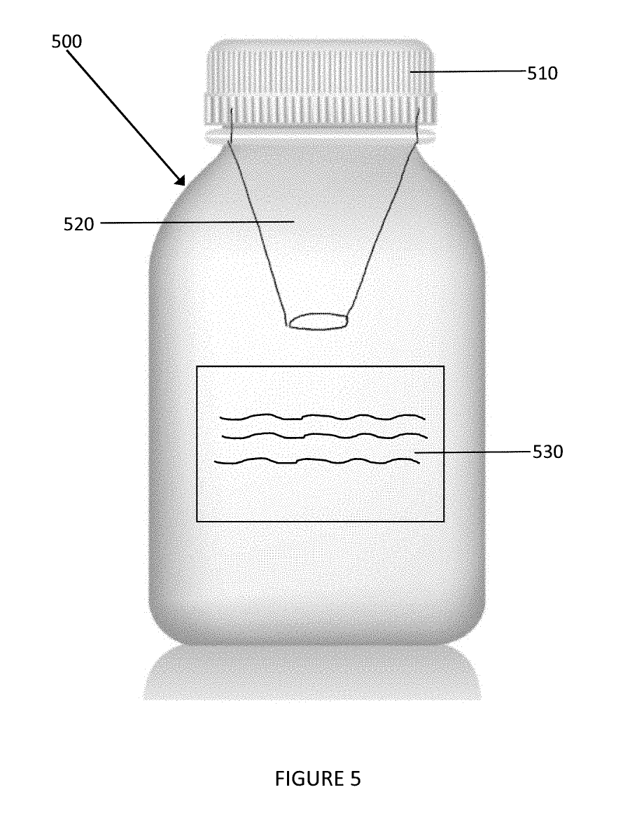

Additional components may be included in the system as desired by the user and based on their habits and dosage requirements. For example, as shown in FIG. 5, an intermediate storage container 500 may be provided which holds an amount substantially larger than dispenser 210, permitting a larger amount of marijuana to be prepared and stored. Storage container 500 may include a locking cap 510, an integrated funnel 520 for filling and pouring, and a container label 530, which is user-writeable similarly to grinder label 125 and dispenser label 260.

The container labels 530 may have visual marks to indicate a match with grinders labels 125 and dispenser labels 260 to form a set and prevent cross-contamination. Matching marks may also assist a third party in preparing and/or dispensing marijuana for a user who is unable to do so themselves.

Similarly, labels may be prepared for other implements (pokers, cleaners, scrapers, etc.) with matching visual marks to other labels to prevent cross-contamination.

While the present invention is directed to the use of legal medical marijuana, it is acknowledged that some jurisdictions have legalized the use of recreational marijuana. The present invention may be used in those jurisdictions for recreational marijuana, or to distinguish between recreational and medical marijuana.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description and all changes which come within the meaning and range of equivalency of the claims are therefore intended to be embraced therein.

What is claimed is:

1. A system for preparing and dispensing marijuana, comprising:
a grinder for preparing marijuana, the grinder comprising a grinder label for a user-designed mark of the contents of the grinder; and
dispenser, the dispenser comprising a storage portion for prepared marijuana, and a dispensing portion, the dispensing portion sized to hold a dispense a fixed amount of prepared marijuana through a dispensing opening, with the storage portion and the dispensing portion being in fluid communication with each other, the dispenser further comprising a dispenser label for a user-designed mark of the contents of the dispenser.

2. The system of claim 1, wherein the grinder label and the dispenser label share common visual elements.

3. The system of claim 2, wherein the common visual elements include one or more of: color, shape and material.

4. The system of claim 1, wherein the dispensing portion is removable, and the system further includes a plurality of removable dispensing portions, each of the dispensing portions sized to dispense a different fixed amount of prepared marijuana.

5. The system of claim 1, wherein the grinder label and the dispenser label are formed from a re-writeable material.

6. The system of claim 5, wherein the re-writeable material is one of: a chalkboard material, a dry-erase material.

7. The system of claim 1, wherein the dispensing opening s secured by a cover with a child-proof locking mechanism.

8. The system of claim 1, further including a case with one or more compartments dimensioned to hold the grinder and the dispenser.

9. The system of claim 8, wherein the case further includes an identity and tracking device.

10. A kit for the preparation and storage of marijuana, comprising:
one or more grinders for preparing marijuana, each grinder comprising a grinder label for a user-designed mark of the contents of each grinder; and
one or more dispensers, each dispenser comprising a storage portion for prepared marijuana, and a dispensing portion, each dispensing portion sized to hold a dispense a fixed amount of prepared marijuana through a dispensing opening, with the storage portion and the dispensing portion being in fluid communication with each other, each dispenser further comprising a dispenser label for a user-designed mark of the contents of each dispenser.

11. The kit of claim 10, wherein each grinder label is paired with one of the dispenser labels and the paired labels share common visual elements.

12. The kit of claim 11, wherein the common visual elements include one or more of: color, shape and material.

13. The kit of claim 1, wherein each dispensing portion is removable, and the kit further includes a plurality of removable dispensing portions, each of the dispensing portions sized to dispense a different fixed amount of prepared marijuana.

14. The kit of claim 1, wherein each grinder label and each dispenser label are formed from a re-writeable material.

15. The kit of claim 14, wherein the re-writeable material is one of: a chalkboard material, a dry-erase material.

16. The kit of claim 10, wherein each dispensing opening is secured by a cover with a child-proof locking mechanism.

17. The kit of claim 10, further including a case with one or more compartments dimensioned to hold each grinder and each dispenser.

18. The kit of claim 17, wherein the case further includes an identity and tracking device.
